(19) United States
(12) Patent Application Publication
(10) Pub. No.: US 2025/0317684 A1
(43) Pub. Date: Oct. 9, 2025

(54) ELECTRONIC DEVICE FOR OUTPUTTING SOUND FROM EXTERNAL DEVICE, OPERATION METHOD THEREOF, AND STORAGE MEDIUM

(71) Applicant: Samsung Electronics Co., Ltd., Suwon-si (KR)

(72) Inventors: Jihye KWON, Suwon-si (KR); Insik MYUNG, Suwon-si (KR); Joayoung LEE, Suwon-si (KR)

(21) Appl. No.: 19/240,916

(22) Filed: Jun. 17, 2025

Related U.S. Application Data
(63) Continuation of application No. PCT/KR2023/019436, filed on Nov. 29, 2023.

(30) Foreign Application Priority Data
Dec. 19, 2022 (KR) 10-2022-0178065
Jan. 3, 2023 (KR) 10-2023-0000633

(51) Int. Cl. H04R 3/00

(52) U.S. Cl. CPC H04R 3/00; H04R 2420/01; H04R 2420/03; H04R 2420/07

(57) ABSTRACT

An electronic device may include a communication module, a speaker unit, a processor, and a memory that stores instructions. The instructions may be configured to, when executed by the processor(s), enable the electronic device to: output a first sound from a first external device through the speaker unit; while outputting the first sound, identify that a condition of switching to a second external device is satisfied; on the basis that the condition of the switching to the second external device is satisfied, store the first sound from the first external device and a second sound from the second external device; mix the first sound with the second sound; while outputting the mixed sound, identify an input for selecting a switch to the second external device; and in response to the input for selecting the switch to the second external device, stop the output of the first sound and output the second sound through the speaker unit.

### CROSS-REFERENCE TO RELATED APPLICATIONS

This application is a continuation application of International Application No. PCT/KR2023/019436 designating the United States, filed on Nov. 29, 2023, in the Korean Intellectual Property Receiving Office and claiming priority to Korean Patent Application No. 10-2022-0178065 filed on Dec. 19, 2022, and Korean Patent Application 10-2023-0000633 filed on Jan. 3, 2023, the disclosures of which are all hereby incorporated by reference herein in their entireties.

### TECHNICAL FIELD

Certain example embodiments may relate to an electronic device for outputting sound from an external device, a method of operating the same, and/or a storage medium.

### BACKGROUND ART

The use of portable electronic devices such as smartphones, tablet PCs, and wearable devices is increasing. As the use of electronic devices rapidly increases, they are also being developed in a form wearable on a user to improve portability and accessibility. For example, wearable electronic devices such as a head-mounted display (HMD) device, a smart watch (or band), a contact lens-type device, a ring-type device, a glove-type device, a shoe-type device, or a clothing-type device are being commercialized.

As an example of an electronic device, a wearable electronic device such as an earphone wearable on or insertable into a user's ear is an electronic device and/or additional device which has a miniaturized speaker unit built therein and is worn on the user's ear (e.g., external auditory canal) to directly emit sound generated from the speaker unit into the user's ear, allowing the user to hear sound even with a small output. In line with the recent consumer trend of placing importance on design, the usability of a wearable electronic device as well as the external design of the wearable electronic device is considered important in the development of wearable electronic devices.

### SUMMARY

According to an example embodiment, an electronic device may include a communication module comprising communication circuitry, a speaker unit comprising a speaker, at least one processor comprising processing circuitry, and memory storing instructions. According to an example embodiment, the instructions may be configured to, when executed by the at least one processor individually and/or collectively, cause the electronic device to output first sound from a first external device through the speaker unit. According to an example embodiment, the instructions may be configured to cause the electronic device to identify that a condition for switching to a second external device is satisfied, while outputting the first sound. According to an example embodiment, the instructions may be configured to cause the electronic device to, based on the condition for switching to the second external device being satisfied, store the first sound from the first external device and second sound from the second external device. According to an example embodiment, the instructions may be configured to cause the electronic device to mix the first sound and the second sound. According to an example embodiment, the instructions may be configured to cause the electronic device to identify an input for selecting switching to the second external device, while outputting the mixed sound. According to an example embodiment, the instructions may be configured to cause the electronic device to stop outputting the first sound and output the second sound through the speaker unit, in response to the input for selecting switching to the second external device.

According to an example embodiment, an operation method for providing sound in the electronic device may include outputting first sound from the first external device through the speaker unit of the electronic device. According to an example embodiment, the operation method may include identifying that a condition for switching to a second external device is satisfied, while outputting the first sound. According to an example embodiment, the operation method may include, based on the condition for switching to the second external device being satisfied, storing the first sound from the first external device and second sound from the second external device. According to an example embodiment, the operation method may include mixing the first sound and the second sound. According to an embodiment, the operation method may include identifying an input for selecting switching to the second external device, while outputting the mixed sound. According to an example embodiment, the operation method may include stopping outputting the first sound and outputting the second sound through the speaker unit, in response to the input for selecting switching to the second external device.

According to an example embodiment, in a storage medium storing instructions configured to, when executed by at least one processor of the electronic device, cause the electronic device to perform at least one operation, the at least one operation may include outputting first sound from a first external device through a speaker unit of the electronic device, identifying that a condition for switching to a second external device is satisfied, while outputting the first sound, based on the condition for switching to the second external device being satisfied, storing the first sound from the first external device and second sound from the second external device, mixing the first sound and the second sound, identifying an input for selecting switching to the second external device, while outputting the mixed sound, and stopping outputting the first sound and outputting the second sound through the speaker unit, in response to the input for selecting switching to the second external device.

### BRIEF DESCRIPTION OF DRAWINGS

FIG. 1 is a block diagram illustrating an electronic device in a network environment according to an example embodiment.

FIG. 2 is a diagram illustrating a sound indicator indicating switching from first sound of a first external device to second sound of a second external device according to an example embodiment.

FIG. 3 is an internal block diagram illustrating an electronic device according to an example embodiment.

FIG. 4 is an internal block diagram illustrating an external device according to an example embodiment.

FIG. 5 is a flowchart illustrating an operation of outputting sound from an external device in an electronic device according to an example embodiment.

FIG. 6 is a flowchart illustrating signal transmission and reception between components during sound mixing in an electronic device according to an example embodiment.

FIG. 7 is a flowchart illustrating signal transmission and reception between components during sound mixing in a server according to an example embodiment.

FIG. 8 is a flowchart illustrating signal transmission and reception between components during sound mixing in an external device according to an example embodiment.

FIG. 9 is an exemplary diagram illustrating a method of switching from first sound of a first external device to second sound of a second external device, while outputting the first sound from the first external device in an electronic device according to an example embodiment.

FIG. 10 is a diagram illustrating conditions for switching from a first external device to a second external device according to an example embodiment.

FIG. 11A is a diagram illustrating a change in sound output magnitude during switching from a first external device to a second external device according to an example embodiment.

FIG. 11B is a diagram illustrating a change in sound output magnitude during attempting to switch from a first external device to a second external device and then returning to the first external device according to an example embodiment.

FIG. 12 is a diagram illustrating a spatial sound effect according to the direction of each of a first external device and a second external device according to an example embodiment.

FIG. 13A is a diagram illustrating a change in a spatial sound effect during switching from a first external device to a second external device according to an example embodiment.

FIG. 13B is a diagram illustrating a change in a spatial sound effect during attempting to switch from a first external device to a second external device and then returning to the first external device according to an example embodiment.

FIG. 14A is a diagram illustrating switching between a noise canceling mode and a transparency sound during switching from a first external device to a second external device according to an example embodiment.

FIG. 14B is a diagram illustrating switching between a noise canceling mode and a transparency sound during attempting to switch from a first external device to a second external device and then returning to the first external device according to an example embodiment.

FIG. 15 is a diagram illustrating a method of outputting sound in a repeated playback manner, when a first external device is disconnected during output of first sound of the first external device according to an example embodiment.

FIG. 16 is a diagram illustrating a method of outputting sound from a different third external device, when a first external device is disconnected during output of first sound of the first external device according to an example embodiment.

FIG. 17 is an exemplary diagram illustrating a method of outputting first sound for first content from a second external device instead of a first external device during output of the first sound for the first content from the first external device in an electronic device according to an example embodiment.

FIG. 18 is an exemplary diagram illustrating a screen for sound mixing-related settings according to an example embodiment.

FIG. 19 is an exemplary diagram illustrating a method of outputting sound in a virtual space according to an example embodiment.

In relation to the description of the drawings, the same or similar reference numerals may be used for the same or similar components.

### DETAILED DESCRIPTION

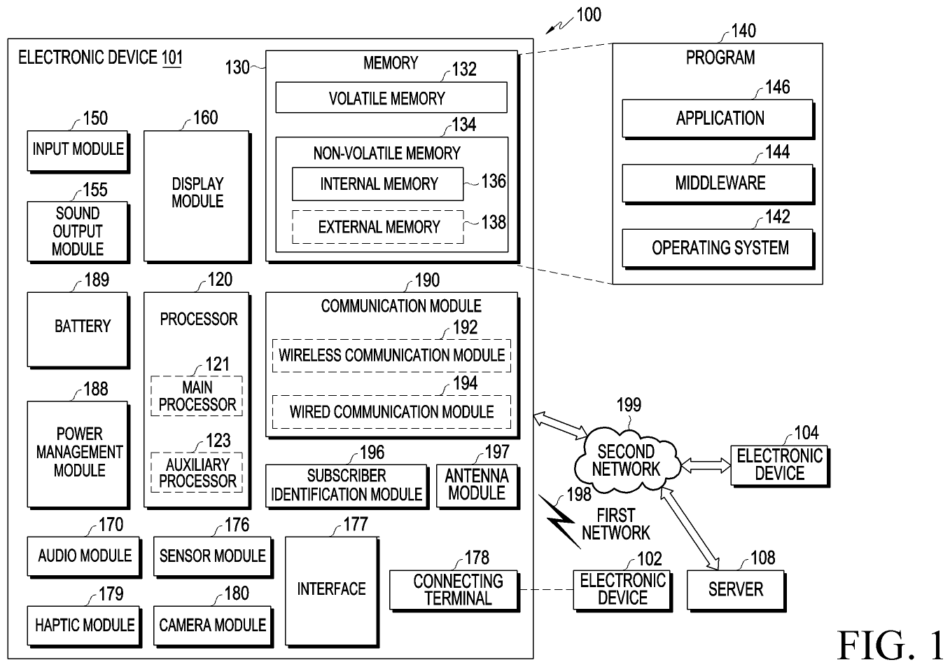

FIG. 1 is a block diagram illustrating an electronic device 101 in a network environment 100 according to various embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the strength of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form an mmWave antenna module. According to an embodiment, the mmWave antenna module may include a printed circuit board, a RFIC disposed on a first surface (e.g., the bottom surface) of the printed circuit board, or adjacent to the first surface and capable of supporting a specified high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the specified high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

In the following detailed description, the same reference numerals or no reference numerals may be assigned to components that may be easily understood from the preceding embodiment, and their detailed description may also be omitted. The electronic device 101 according to an embodiment of the disclosure may be implemented by selectively combining components of different embodiments, and a component of an embodiment may be replaced by a component of another embodiment. For example, it is to be noted that the disclosure is not limited to a specific drawing or embodiment.

An electronic device may be connected to an external electronic device having a sound (or audio) output function via a wireless interface. While being connected to the external device, the electronic device may output sound data through either the electronic device or the external device according to a user's selection. The electronic device may include a wearable electronic device such as an earphone or a wireless headset as a sound output device. Further, since the electronic device is connectable to various types of external devices, the user may want to receive an audio service in more diverse manners depending on the user's environment or situation. For example, while the electronic device is connected to two or more external devices, the user holding the electronic device may move or want to listen to sound from another external device rather than sound from a current connected external device. When the electronic device automatically performs an operation of switching to another external device among the connected external devices, this may be switching that does not reflect the user's intention. In addition, switching through a settings screen may be inconvenient because the user should select switching to a desired external device on the settings screen. Moreover, when the switching fails, sound from an external device may be output to the outside through a speaker of the external device rather than the electronic device. Therefore, it may be desired to prevent or reduce chances of a situation in which sound is unintentionally output through the speaker of the external device during an attempt of switching to the external device.

Therefore, when external device switching is required, such as when the user's location becomes far from a first external device and close to a second external device, it may be desirable to identify the user's intention regarding the switching by allowing the user to recognize a switching time point. An embodiment relates to an electronic device for outputting sound from an external device by reflecting a user's intention at a time when switching between external devices is required, a method of operating the same, and a storage medium.

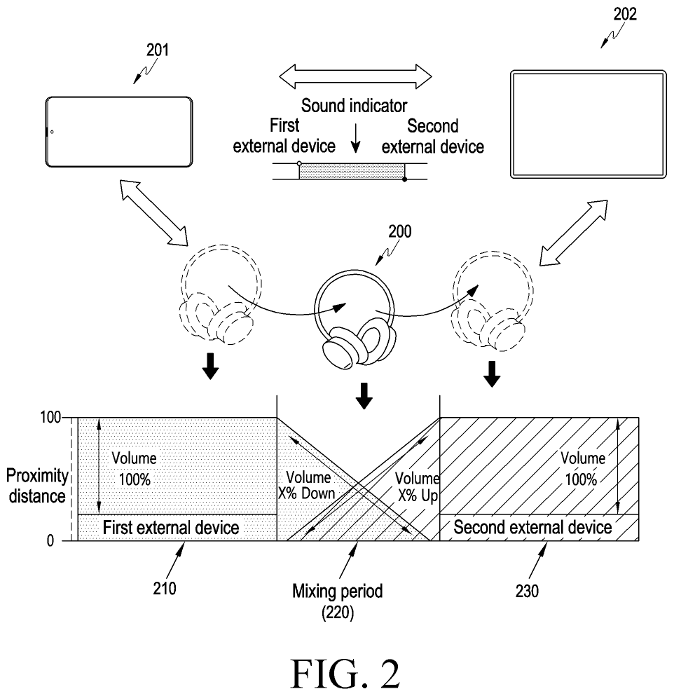

FIG. 2 is a diagram illustrating a sound indicator indicating switching from first sound of a first external device to second sound of a second external device according to an embodiment.

Referring to FIG. 2, an electronic device 200 may be in a state where it is communication-connected to two or more external devices 201 and 202, respectively. For example, a first external device 201 may transmit sound according to audio playback to the electronic device 200 as a wireless signal through a communication channel so that the sound may be output through a speaker of the electronic device 200. The electronic device 200 may render the wireless signal to output sound so that a user may hear it. When the electronic device 200 held by the user moves away from the first external device 201 and becomes closer to the second external device 202, the user may want to listen to sound from the second external device 202 according to audio playback through the speaker of the electronic device 200.

According to an embodiment, when the first external device 201 and the second external device 202 are located within a specific radius centered on the electronic device 200, and the electronic device 200 is close to the first external device 201 and then becomes closer to the second external device 202, the electronic device 200 may be configured to receive audio data from each of the first external device 201 and the second external device 202 and mix the received audio data. According to an embodiment, the mixed audio data may be used to notify that device switching for sound output is possible.

According to an embodiment, the electronic device 200 may gradually decrease the volume level of sound output from the first external device 201 during output of the sound from the first external device 201, and gradually increase the volume level of sound from the second external device 202 to the original volume level.

For example, as illustrated in FIG. 2, on the assumption that the distance to the first external device 201 is 100, the volume level of sound output from the first external device 201 according to audio playback through the speaker of the electronic device 200 may be 100 during a first period 210. As the electronic device 200 moves away from the first external device 201 and approaches the second external device 202, it may control to gradually decrease the volume level of the sound from the first external device 201 and gradually increase the volume level of sound from the second external device 202 during a mixing period 220. Further, when switching to the second external device 202 is determined by the user's selection after the electronic device 200 moves closer to the second external device 202 than to the first external device 201, the electronic device 200 may control to output the sound from the second external device 202 at the original volume level, for example, 100 according to audio playback, rather than the sound from the first external device 201, through the speaker of the electronic device 200.

According to an embodiment, the electronic device 200 may use a sound indicator to notify the user that sound switching between the first external device 201 and the second external device 202 is possible. According to an embodiment, the sound indicator may be implemented using a sound effect such as fade-out/fade-in.

For example, the volume level of sound from the first external device 201 may be gradually reduced while the volume level of sound from the second external device 202 may be gradually increased, so that disconnection from the first external device 201 and switching to a connection to the second external device 202 may be smoothly performed. A sound effect of gradually reducing the volume level of the sound of the first external device 201 may be referred to as fade-out, and a sound effect of gradually increasing the volume level of the sound of the second external device 202 may be referred to as fade-in. There may be various implementations for how to increase and decrease a sound volume for sound effects such as fade-out and fade-in.

For this purpose, in an embodiment, the electronic device 200 may temporarily store at least a portion of audio data from each of the first external device 201 and the second external device 202 in a buffer, for sound effects such as fade-out and fade-in. The electronic device 200 may mix the two audio data stored in the buffer. For example, the electronic device may generate mixed data in which audio data currently being played is faded out and audio data to be played in the future is faded in, and output the mixed data through the speaker.

As described above, even if the electronic device 200 does not include a user interface such as a display for selecting a sound switching target or a sound connection target, the user may intuitively recognize that device switching is possible by listening to the sound indicator. In addition, the user may be guided to select a sound switching target by notifying the user that switching is possible using the sound indicator, so that the electronic device 200 may clearly understand the user's intention as to whether the user actually wants sound switching to another external device. Accordingly, the user may or may not select switching to a new external device as a sound switching target as needed, and may accurately select the next sound switching target while the user is moving.

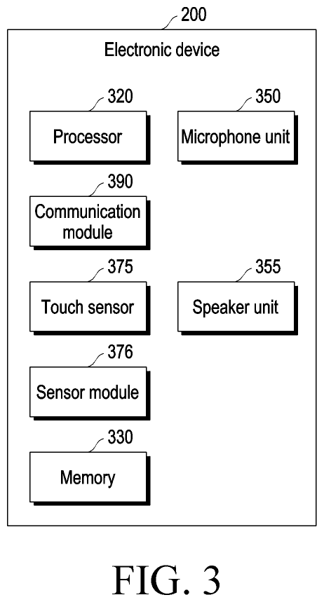

FIG. 3 is an internal block diagram illustrating an electronic device according to an embodiment. The electronic device 200 of FIG. 3 may be all or a portion of the electronic device 101 of FIG. 1. In describing the electronic device 200 of FIG. 3, a detailed description of a component similar to that of the embodiment of FIG. 1 or a component easily understandable from the embodiment of FIG. 1 may be omitted.

According to an embodiment, the electronic device 200 may include a wearable electronic device such as an earphone or a wireless headset, as a sound output device that may output sound from the external device 201 or 202 according to audio playback, on behalf of the external device 201 or 202. For example, when it is wearable on the user's body (e.g., an ear), the electronic device 200 may also be referred to as an earphone, an ear piece, an ear bud, or an auditory device. When the electronic device 200 is a wireless earphone wearable on the user's body (e.g., ear), the electronic device 200 may be composed of a pair of devices (e.g., an earphone wearable on the right ear and an earphone wearable on the left ear), and the pair of devices may include the same components. Without being limited to what has been described, the electronic device 200 may be wireless earphones of various types.

According to an embodiment, a sound effect such as a sound indicator is not provided only when sound is output through a wearable electronic device such as an earphone or a wireless headset, but may also be provided in response to sound output through a portable speaker. Accordingly, as far as it is a device that provides a function allowing a user to listen while being worn or carried by the user, the type of the electronic device 200 may not be limited thereto, and it may be referred to as a hearable device.

The electronic device 200 may be connected to the external devices 201 and 202 capable of sound reproduction and sound output, such as a TV, an audio play device, a radio, a Bluetooth speaker, a smartphone, a tablet PC, or a desktop PC. For example, a processor 320 (e.g., the processor 120 of FIG. 1) may perform wireless communication with an external device (e.g., the electronic devices 102 and 104 of FIG. 1, and the external devices 201 and 202 of FIG. 2) such as a smartphone, a tablet PC, or a personal computer through a first network (e.g., the first network 198 of FIG. 1) or a second network (e.g., the second network 199 of FIG. 1) by using a communication module 390 (e.g., the communication module 190 of FIG. 1).

Referring to FIG. 3, the electronic device 200 may include the processor 320, memory 330, the communication module 390, a touch sensor 375, a sensor module 376, a microphone unit 350, and/or a speaker unit 355 (e.g., the audio output module 155 of FIG. 1).

According to an embodiment, the speaker unit (or built-in speaker) 355 may receive an electric signal from the processor 320, generate sound, and output the sound to the outside.

According to an embodiment, the microphone unit 350 may include a plurality of microphones. The microphone unit 350 or the electronic device 200 may detect the direction of sound or detect external sound through the plurality of microphones. The electronic device 200 or the processor 320 may suppress or remove noise based on the external sound detected by the microphone unit 350.

According to an embodiment, the memory 330 may store information for communication with at least one external device among a plurality of external devices, and transmitted and received data. For example, the memory 330 may store a program supporting a function required for providing a sound indicator effect. Further, the processor 320 may receive audio data being played from the first external device 201 through the communication module 390 and store a specific amount of the audio data in the memory 330 to output first sound according to the audio data.

According to an embodiment, the processor 320 may identify whether a condition for switching to the second external device 202 is satisfied, while outputting the first sound from the first external device 201. The operation of identifying whether the condition for switching to the second external device 202 is satisfied may be an operation of identifying whether a sound connection target or a sound switching target is detected.

According to an embodiment, when the electronic device 200 is closer to the second external device 202 than to the first external device 201, the processor 320 may identify that a sound connection target has been detected. For example, the processor 320 may identify the second external device 202 as a sound connection target by identifying at least one of a direction in which the electronic device 200 is directed or a distance to the second external device 202. Specifically, when the distance to the second external device 202 is within a threshold distance, the processor 320 may identify that the condition for switching to the second external device 202 is satisfied, thereby identifying the second external device 202 as a sound connection target.

According to an embodiment, when detecting an event for outputting sound from the second external device 202, the processor 320 may identify the second external device 202 as a sound connection target. For example, when audio playback starts in the second external device 202, or when sound information is included in an interface component or activated application executed in the second external device 202, the second external device 202 may attempt to establish a sound connection with the electronic device 200, and in response, the electronic device 200 may track the sound connection attempt state of the second external device 202.

In response to the second external device 202 being identified as a sound switching target, the processor 320 may receive audio data being played on the second external device 202, while outputting the first sound from the first external device 201, and store a specific amount of the audio data in the memory 330 to output second sound according to the audio data.

According to an embodiment, additional data is required to process the sound indicator effect for indicating the presence of a sound connection target, and a buffer in the memory 330 may be used to store the additional data. For example, the processor 320 may temporarily store audio data from the first external device 201 in a first buffer, and temporarily store audio data from the second external device 202 in a second buffer. The buffer in which the audio data is stored may correspond to a cache of the memory 330. The processor 320 may generate mixed data by mixing the stored audio data to produce the sound indicator effect, and may provide the sound indicator effect by outputting the mixed data through a speaker.

According to an embodiment, the memory 330 may store instructions which when executed, control the processor 320 to perform various operations. According to an embodiment, the memory 330 may be operatively connected to the communication module 390, the speaker unit 355, and the processor 320, and store instructions which control to output first sound from the first external device 201 through the speaker unit 355, to identify that a condition for switching to the second external device 202 is satisfied, while outputting the first sound, to store the first sound from the first external device 201 and second sound from the second external device 202, to mix the first sound and the second sound based on the satisfaction of the condition for switching to the second external device 202, to identify an input for selecting switching to the second external device 202, while outputting the mixed sound, and to stop outputting the first sound and output the second sound through the speaker unit 355, in response to the input for selecting switching to the second external device 202.

For example, the processor 320 may generate mixed data in which sound from the currently sound-connected first external device 201 is faded out and sound from the second external device 202 to be sound-connected in the future is faded in, and output the mixed data through the speaker unit 355.

According to an embodiment, the processor 320 may receive a user input for confirming switching to a new sound connection target, while outputting the mixed data. According to an embodiment, the processor 320 may identify the user input for confirming switching to the new sound connection target by identifying at least one of a touch input of a specified type detected through the touch sensor 375, an interaction input of a specified type detected through the sensor module 376, or a voice input through the microphone unit 350 of the electronic device 200.

According to an embodiment, the touch sensor 375 may be a capacitive touch sensor or pressure-sensitive touch sensor for detecting a touch. The touch sensor 375 may detect a touch of a specified type, such as a single touch or tap, a double touch, or a long touch. For example, a single touch or tap may correspond to a command to confirm switching, and a double touch or tap may correspond to a command to cancel switching. In addition, in the case of the electronic device 200 such as a pair of left and right earphones, a left panel touch may correspond to a command to switch to an external device located on the left side of the electronic device 200, and a right panel touch may correspond to a command to switch to an external device located on the right side of the electronic device 200.

According to an embodiment, the sensor module 376 (e.g., the sensor module 176 of FIG. 1) may generate an electric signal or data value corresponding to an internal operating state or external environmental state of the electronic device 200. An interaction input of a specified type may be detected using the sensor module 376 including a 6-axis sensor, and a user interaction of nodding the head to the left may correspond to a command to switch to the external device located on the left side of the electronic device 200, and a user interaction of nodding the head to the right may correspond to a command to switch to the external device located on the right side of the electronic device 200.

A voice input through the microphone unit 350 of the electronic device 200 may correspond to a spoken command such as ‘Switch’. In addition, when the electronic device 200 is provided with a hardware button, a short press of the button once may correspond to a command to confirm switching, and a long press may correspond to a command to cancel switching.

As described above, according to an embodiment, the user may naturally select a desired sound connection target in a continuous sound experience without sound interruptions during switching to a sound connection target. In addition, as playback data of the two external devices 201 and 202 are mixed during switching to the sound connection target, the user may experience listening to sound within the same profile even if it is not data based on a Bluetooth protocol.

According to an embodiment, the communication module 390 may be communication-connected to at least one external device. According to an embodiment, the communication module 390 may be connected to one or more external devices (e.g., the external devices 201 and 202 of FIG. 2) in a 1:1 or 1:n connection method. In addition, the communication module 390 may be wirelessly connected to external devices in various communication schemes. For example, the communication module 390 may be configured to be connected to an external device through at least one of LTE communication, Wi-Fi Direct communication, or bidirectional Bluetooth communication. Further, the communication module 390 may be configured to be connected to an external device using a cloud-based ID. In this way, the processor 320 may be connected to n external devices in a 1:n connection method supported by the communication module 390, to which the supported communication scheme is not limited.

According to an embodiment, the communication module 390 may operate based on at least one of an ultra wide band (UWB) communication scheme or a Bluetooth low energy (BLE) communication scheme.

For example, the communication module 390 may include a UWB communication module. The UWB communication module may support the electronic device 200 to perform UWB communication with an external device. The UWB communication module may measure the distance between the electronic device 200 and the external device through UWB communication. The UWB communication module may measure a direction (e.g., arrival angle (AOA)) of the external device, using a plurality of multiple antennas.

The sensor module 376 according to an embodiment may include a gyro sensor, an acceleration sensor, and/or a geomagnetic sensor that detects a state (e.g., posture) of the electronic device 200. For example, the electronic device 200 may determine a relative azimuth with respect to a reference azimuth using the geomagnetic sensor. The electronic device 200 may obtain a final azimuth based on UWB according to the relative azimuth with respect to the reference azimuth and a UWB AOA using the geomagnetic sensor. The sensor module 376 may be used as a 9-axis motion sensor using the gyro sensor, the acceleration sensor, and the geomagnetic sensor.

In an embodiment, the processor 320 may obtain location-related information about n external devices. For example, the n external devices may be devices which are capable of playing sound or are playing sound while being connected to the electronic device 200. The location-related information may be used to identify the locations or directions of the external devices within a specific radius or a specific location with respect to the electronic device 200. For example, the processor 320 may obtain location-related information about the n external devices, using a communication scheme of the communication module 390 and a measurement value of the sensor module 376. Further, the processor 320 may receive, from each of the n external devices, location-related information including at least one of, for example, distance information with respect to the electronic device 200, horizontal angle information with respect to the electronic device 200, direction information about the external device, and/or altitude information about the external device. The processor 320 may determine a location to which the electronic device 200 has been moved based on the location-related information.

The processor 320 may identify whether the electronic device 200 is close to another external device, while outputting sound being played in the first external device 201 among the n external devices through the speaker unit 355. For example, when two or more external devices are identified as closer to the electronic device 200 than the first external device 201, one of the identified external devices, for example, the second external device 202, may be identified as a sound connection target according to their priorities. The user may preset the priority of a desired device to play sound.

In response to the identification of the closer external device, the processor 320 may output an output sound corresponding to a sound indicator effect to notify the user that switching is possible. The output of the sound indicator effect in this way may guide the user to make a selection regarding the sound connection target.

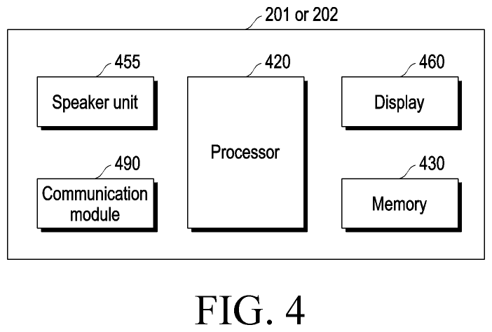

FIG. 4 is an internal block diagram illustrating an external device according to an embodiment.

According to an embodiment, the first external device 201 may include a processor 420, memory 430, a speaker unit 455, a display 460, and/or a communication module 490. Similarly, the second external device 202 may include the same components as the first external device 201. All components illustrated in FIG. 4 are not essential components of the first external device 201, and the first external device 201 may be implemented with more or fewer components than the components illustrated in FIG. 4. In describing the first external device 201 of FIG. 4, a detailed description of components similar to those of the embodiment of FIG. 1 or components easily understood from the embodiment of FIG. 1 is omitted.

According to an embodiment, the first external device 201 of FIG. 4 may be a device capable of playing or outputting sound, while being connected to the electronic device 200 of FIG. 3. For example, the first external device 201 may be connected to the electronic device 200 such as earphones or a headset. In addition, the first external device 201 may be one or more of a plurality of external devices located in various locations, and may be connected to the second external device 202 through a smart home network.

According to an embodiment, the processor 420 may output sound through the speaker unit 455 in response to an audio playback request. When the electronic device 200 attempts to switch to the external device 201 as a sound connection target, the processor 420 may limit the output of sound to the outside through the speaker unit 455. For example, from the perspective of the second external device 202, it may determine that sound output from the second external device 202 should be activated (or the speaker unit 455 should be turned on) in response to detection of a switching attempt for sound connection to the electronic device 200. However, since sound switching between the second external device 202 and the electronic device 200 is not confirmed by the user, it may be desired to prevent or reduce chances of sound from being output to the outside through the speaker unit 455 of the second external device 202. Therefore, the processor 420 of the second external device 202 may control sound not to be output to the outside through the speaker unit 455 of the second external device 202 until sound switching between the second external device 202 and the electronic device 200 is confirmed or rejected. Likewise, the processor 420 of the first external device 201 may also control sound not to be output to the outside through the speaker unit 455 of the first external device 201 until the sound switching between the second external device 202 and the electronic device 200 is confirmed or rejected.

For example, the output of sound through the speaker of each of the first external device 201 and the second external device 202 may be temporarily restricted during a specified time period, while the sound output is switched from the first external device 201 to the second external device 202. To this end, each of the first external device 201 and the second external device 202 may temporarily turn off its speaker unit. In addition, the processor 420 may control sound to be output through the speaker of the electronic device 200, while being connected to the electronic device 200. The speaker unit 455 may be deactivated, while sound is output through the speaker of the electronic device 200. For example, even if the sound output through the speaker of the electronic device 200 is paused, the sound output through the speaker unit 455 may be restricted unless the connection to the electronic device 200 is terminated.

According to an embodiment, the processor 420 may display a screen related to audio playback through the display 460. For example, when audio playback starts or when sound information is included in an executed interface component or an activated application, the processor 420 may attempt to establish a sound connection with the electronic device 200. The processor 420 may detect a user input for selecting the electronic device 200 as a sound output target through the display 460, and display an object and guidance information related to a sound connection attempt state in response to the user input on at least a portion of the display 460. In addition, the processor 420 may transmit sound data to the electronic device 200 through the communication module 490 in response to the user input, so that sound is output through the speaker of the electronic device 200.

According to an embodiment, the communication module 490 may establish a communication connection with the electronic device 200 and operate based on at least one of a UWB communication scheme or a BLE communication scheme. According to an embodiment, although the electronic device 200 may identify whether it is close to each external device 201 or 202 and obtain location-related information, each of the external devices 201 and 202 may identify whether it is close to the electronic device 200 and provide location-related information to the electronic device 200.

According to an embodiment, the electronic device 200 may include the communication module 390 comprising communication circuitry, the speaker unit 355 comprising a speaker(s), the processor 320 comprising processing circuitry, and the memory 330 storing instructions. According to an embodiment, the instructions may be configured to, when executed by the processor, cause the electronic device to output first sound from the first external device 201 through the speaker unit, identify that a condition for switching to the second external device 202 is satisfied, while outputting the first sound, store the first sound from the first external device and second sound from the second external device, based on the condition for switching to the second external device being satisfied, mix the first sound and the second sound, and identify an input for selecting switching to the second external device, while outputting the mixed sound, and stop outputting the first sound and output the second sound through the speaker unit, in response to the input for selecting switching to the second external device.

According to an embodiment, the instructions may be configured to cause the electronic device to identify at least one of a direction in which the electronic device is directed or a distance to the second external device, and identify that the condition for switching to the second external device is satisfied by identifying the at least one of the direction in which the electronic device is directed or the distance to the second external device.

According to an embodiment, the instructions may be configured to cause the electronic device to, in case that the distance from the electronic device to the second external device is within a threshold distance with respect to the electronic device, identify that the condition for switching to the second external device is satisfied.

According to an embodiment, the instructions may be configured to cause the electronic device to detect an event associated with output of the second sound from the second external device, and identify that the condition for switching to the second external device is satisfied, in response to the detection of the event.

According to an embodiment, the instructions may be configured to cause the electronic device to identify an input for selecting switching to the second external device by identifying at least one of a touch input of a specified type, an interaction input of a specified type, or a voice input through a microphone of the electronic device.

According to an embodiment, the instructions may be configured to cause the electronic device to mix the first sound and the second sound by identifying at least one of a position, direction, or distance of each of the first external device and the second external device with respect to the electronic device, and adjusting output magnitudes of the first sound and the second sound based on the identified at least one of the position, direction, or distance of each of the first external device and the second external device.

According to an embodiment, the instructions may be configured to cause the electronic device to identify the at least one of a position, direction, or distance of each of the first external device and the second external device with respect to the electronic device, based on at least one of a UWB communication scheme or BLE communication scheme of the communication module.

According to an embodiment, the instructions may be configured to cause the electronic device to mix the first sound having an output magnitude gradually decreasing as a distance to the first external device increases, and the second sound having an output magnitude gradually increasing as the distance to the second external device decreases.

According to an embodiment, the instructions may be configured to cause the electronic device to, in case that the electronic device is in a noise canceling mode, switch from the noise canceling mode to a transparency mode when outputting the mixed sound, and return from the transparency mode to the noise canceling mode.

According to an embodiment, the instructions may be configured to cause the electronic device to limit the output of the second sound through the speaker of the second external device, in response to the input for selecting switching to the second external device.

According to an embodiment, the instructions may be configured to cause the electronic device to, in case that the input for selecting switching to the second external device is not identified, stop outputting the second sound and output the first sound through the speaker.

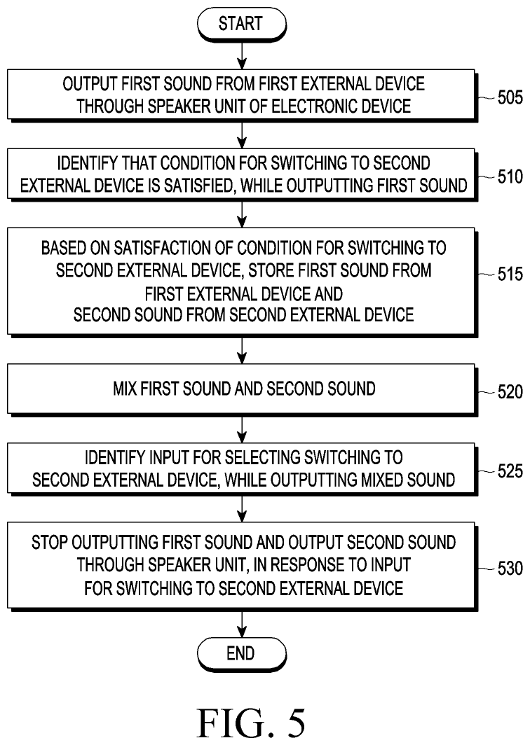

FIG. 5 is a flowchart illustrating an operation of outputting sound from an external device in an electronic device according to an embodiment.

Referring to FIG. 5, the operation method may include operations 505 to 530. Each operation of the operation method of FIG. 5 may be performed by an electronic device (e.g., the electronic device 200 of FIGS. 2 and 3) or at least one processor (e.g., the processor 320 of FIG. 3 comprising processing circuitry) of the electronic device. In an embodiment, at least one of operations 505 to 530 may be omitted, the order of some operations may be changed, or another operation may be added.

In operation 505, the electronic device 200 may output first sound from the first external device 201 through the speaker unit 355 of the electronic device. In an embodiment, the electronic device 200 may be in a state where it is communication-connected to n external devices. For example, the electronic device 200 may be in a state where it is communication-connected to various IoT devices (e.g., home appliances to which IoT technology is applied) that form a home network.

Further, the electronic device 200 may receive sound-related data including at least one of sound data (or audio data) of a size that may be played back during a specific time period, a playback period timing, or a volume level from the first external device 201 in order to output the first sound from the first external device 201. The electronic device 200 may temporarily store the sound-related data for the first external device 201 in the first buffer.

In operation 510, the electronic device 200 may identify that a condition for switching to the second external device 202 is satisfied, while outputting the first sound.

According to an embodiment, the operation of identifying that the condition for switching to the second external device 202 is satisfied may include an operation of identifying at least one of a direction in which the electronic device 200 is directed or a distance to the second external device 202, and an operation of identifying that the condition for switching to the second external device is satisfied by identifying the at least one of the direction in which the electronic device 200 is directed or the distance to the second external device 202.

According to an embodiment, the operation of identifying that the condition for switching to the second external device 202 is satisfied may include an operation of identifying that the condition for switching to the second external device 202 is satisfied, in case that the distance from the electronic device 200 to the second external device 202 is within a threshold distance with respect to the electronic device.

According to an embodiment, the operation of identifying that the condition for switching to the second external device 202 is satisfied may include an operation of detecting an event associated with output of second sound from the second external device 202, and an operation of identifying that the condition for switching to the second external device 202 is satisfied, in response to the detection of the event.

In operation 515, the electronic device 200 may store the first sound from the first external device 201 and the second sound from the second external device 202, based on the condition for switching to the second external device 202 being satisfied.

The electronic device 200 may receive sound-related data including at least one of sound data (or audio data) of a size that may be played back during a specific time period, a playback period timing, or a volume level from the second external device 201. The electronic device 200 may temporarily store the sound-related data for the second external device 202 in the second buffer.

In operation 520, the electronic device 200 may mix the first sound and the second sound.

According to an embodiment, the operation of mixing the first sound and the second sound may include an operation of identifying at least one of a position, direction, or distance of each of the first external device 201 and the second external device 202 with respect to the electronic device 200, and an operation of mixing the first sound and the second sound by adjusting output magnitudes of the first sound and the second sound, based on the identified at least one of the position, direction, or distance of each of the first external device 201 and the second external device 202.

According to an embodiment, the operation of mixing the first sound and the second sound may include an operation of mixing the first sound having an output magnitude gradually decreasing as the distance to the first external device 201 increases, and the second sound having an output magnitude gradually increasing as the distance to the second external device 202 decreases.

For example, the electronic device 200 may generate mixed data in which sound data currently being played is faded out and sound data to be played in the future is faded in, and output the mixed data through the speaker of the electronic device 200.

In operation 525, the electronic device 200 may identify an input for selecting switching to the second external device 202, while outputting the mixed sound.

According to an embodiment, the operation of identifying the input for selecting switching to the second external device 202 may include an operation of identifying the input for selecting switching to the second external device 202 by identifying at least one of a touch input of a specified type, an interaction input of a specified type, or a voice input via a microphone of the electronic device 200.

In operation 530, the electronic device 200 may stop outputting the first sound and output the second sound through the speaker, in response to the input for selecting switching to the second external device 202. As the mixed sound is output in this way, a time for selecting or canceling switching to a new sound connection target other than the currently connected target may be provided to the user.

According to an embodiment, when the electronic device 200 is in the noise canceling mode, it may perform an operation of switching from the noise canceling mode to the transparency mode, when outputting the mixed sound. According to an embodiment, the electronic device 200 may perform an operation of returning from transparency mode to the noise canceling mode, in response to the input for selecting switching to the second external device 202.

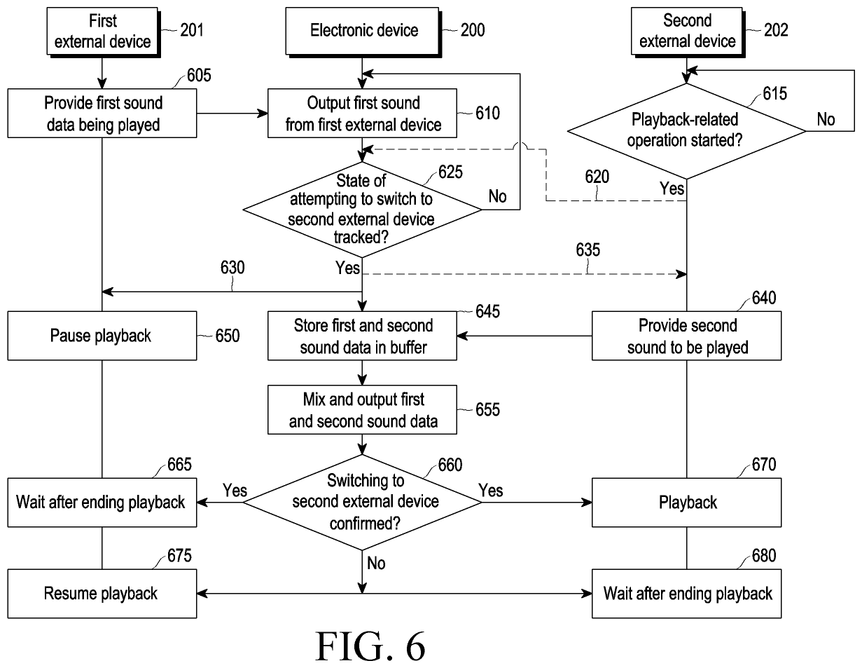

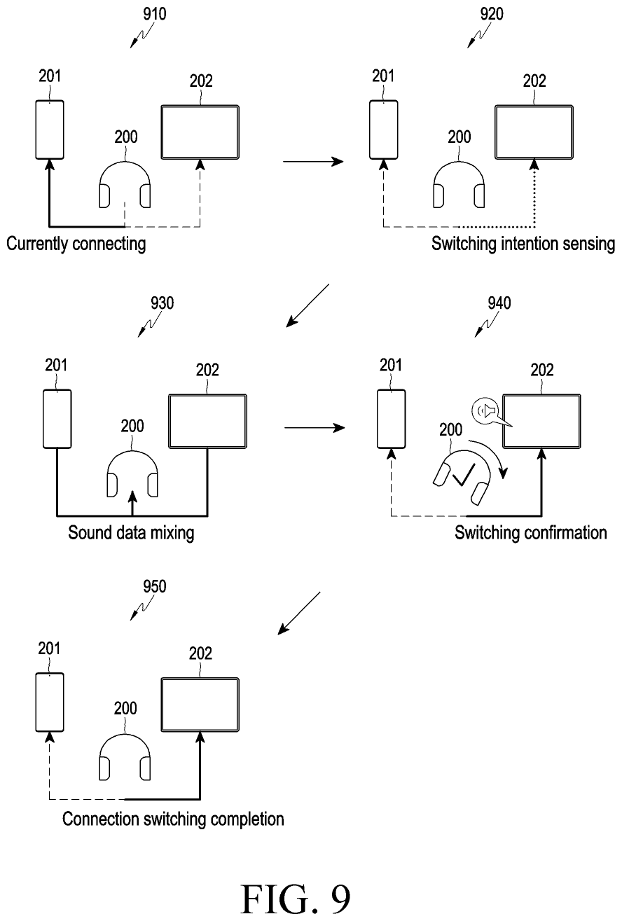

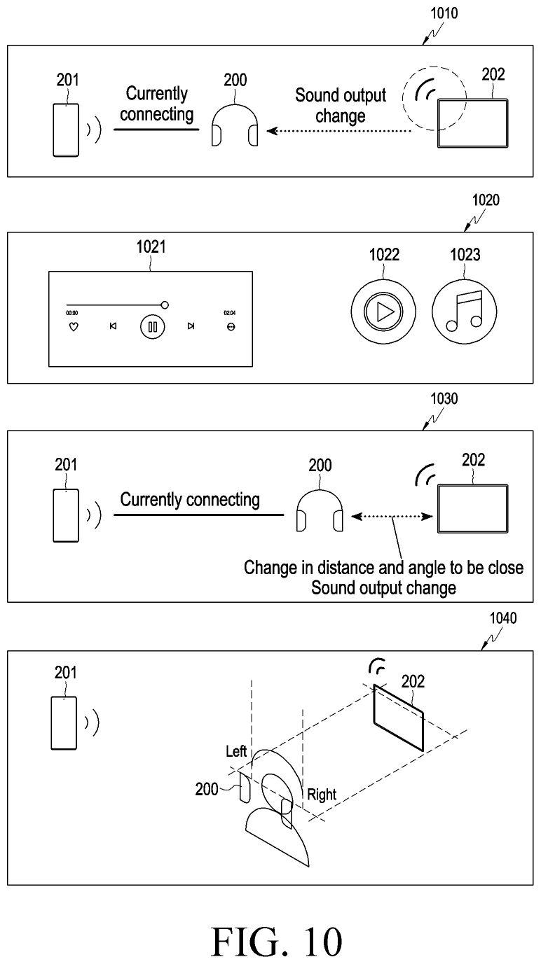

FIG. 6 is a flowchart illustrating signal transmission and reception between components during sound mixing in an electronic device according to an embodiment. In order to help understand the description of FIG. 6, FIGS. 9 and 10 will be referred to. FIG. 9 is an exemplary diagram illustrating a method of switching from first sound from a first external device to second sound from a second external device during output of the first sound from the first external device in an electronic device according to an embodiment, and FIG. 10 is a diagram illustrating conditions for switching from the first external device to the second external device according to an embodiment.

In operation 605, the first external device 201 may provide first sound data being played to the electronic device 200. For example, the first external device 201 may transmit the first sound data for sound output according to audio playback to the electronic device 200 in an audio mirroring manner. The method of providing sound data according to audio playback from the first external device 201 to the electronic device 200 may not be limited thereto.

In operation 610, the electronic device 200 may output the first sound from the first external device 201. For example, the electronic device 200 may temporarily store sound data required to output the first sound in a buffer in units of a specified amount. Accordingly, the electronic device 200 may continuously receive and store every specific amount of data (e.g., in units of 20 seconds) from a current playback time. In addition, the data temporarily stored in the buffer may be deleted in units of a specified size in the order of data that has been completely played back, that is, data having a playback time past. Referring to FIG. 9, as indicated by reference numeral 910, the electronic device 200 may output the first sound from the first external device 201 through the speaker of the electronic device 200, while currently connected to the first external device 201. On the other hand, the second external device 202 may be in a state where it is communication-connected to the electronic device 200 but waiting for a sound connection to the electronic device 200.

In operation 615, the second external device 202 may identify whether a playback-related operation is started. In response to the start of the playback-related operation, the electronic device 200 may identify whether a state of attempting to switch to the second external device 202 is tracked in operation 625. Referring to FIG. 9, the electronic device 200 may sense a switching intention, as indicated by reference numeral 920. Referring to FIG. 10, the electronic device 200 may identify the switching attempt state, based on at least one of a case 1010 where sound playback starts in the second external device 202 and thus an event for sound output occurs, a case 1020 where an interface component executed in the second external device 202 includes an audio control function 1021 or an activated application 1022 or 1023 includes sound information, a case 1030 where the distance and angle between the electronic device 200 and the second external device 202 change so that they are close to each other, or a case 1040 where a horizontal angle is formed to be a threshold or less between each of the left and right sides of the electronic device 200 and the second external device 202.

As the state of attempting switching to the second external device 202 is tracked, the electronic device 200 may notify the first external device 201 of this in operation 630. In response, the first external device 201 may pause the playback in operation 650.

The electronic device 200 may notify the second external device 202 that the switching attempt state has been detected in operation 635. In response, the second external device 202 may provide second sound data to be played to the electronic device 200 in operation 640. The electronic device 200 may store the first and second sound data in the buffer in operation 645, and mix and output the first and second sound data in operation 655. For example, the first and second sound data stored in the buffer in operation 645 may be data used to generate a sound indicator. In a sound transition period during which the sound indicator is output, the mixed data may be output through the speaker of the electronic device 200. When the sound transition period is set to 10 seconds, the first sound data that may be played back for 10 seconds may be temporarily stored in the buffer, and the second sound data to be played back for 10 seconds may be temporarily stored in the buffer. Using the temporarily stored data, the electronic device 200 may generate mixed data in which the first sound data is processed to be faded out and the second sound data is processed to be faded in, for the 10-second period. In an embodiment, as the state of attempting switching to the second external device 202 is tracked, the first external device 201 pauses the playback in operation 650, by way of example. However, operation 650 may be performed in response to operation 645 in which the first and second sound data are stored in the buffer, and the order of operation for pausing the playback may not be limited thereto.

Operation 655 of mixing and outputting the first and second sound data will be described with reference to FIG. 9. Referring to FIG. 9, when the electronic device 200 detects a switching intention as indicated by reference numeral 930, sound data may be mixed. For example, the electronic device 200 may output the mixed data through the speaker of the electronic device 200.

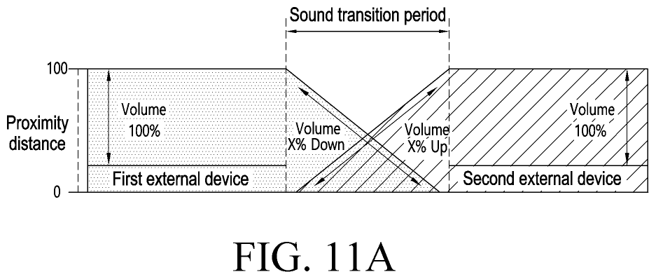

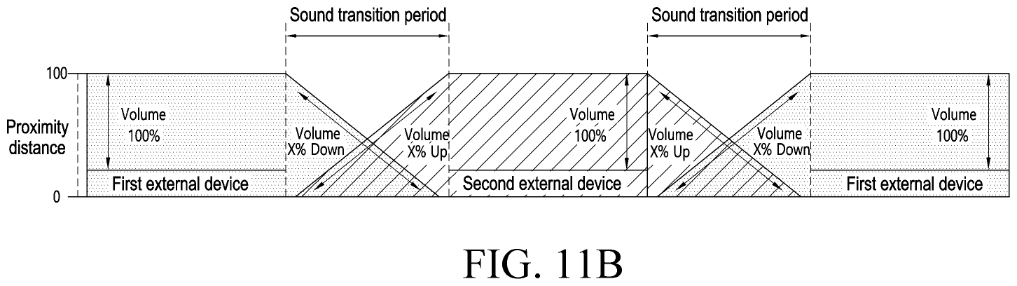

The method of mixing and outputting the first and second sound data will be described with reference to FIG. 11A. FIG. 11A is a diagram illustrating changes in the output magnitude of sound during switching from a first external device to a second external device according to an embodiment.

Referring to FIG. 11A, on assumption that the proximity distance to the first external device 201 is 100, the volume level of sound output from the first external device 201 according to audio playback through the speaker of the electronic device 200 may be 100%. As the electronic device 200 moves away from the first external device 201 and approaches the second external device 202, the volume level of the sound from the first external device 201 may be gradually reduced, and the volume level of the sound from the second external device 202 may be gradually increased, in the sound transition period. In the sound transition period, mixed data may be output through the speaker of the electronic device 200. When the sound transition period is set to 10 seconds, the first sound data that may be played back for 10 seconds may be temporarily stored in the buffer, and the second sound data that will be played back for 10 seconds may be temporarily stored in the buffer. Accordingly, the electronic device 200 may generate mixed data in which the first sound data is processed to be faded out and the second sound data is processed to be faded in, for the 10-second period.

According to an embodiment, the electronic device 200 may control to gradually decrease the volume level of the sound from the first external device 201 and gradually increase the volume level of the sound from the second external device according to the distances to the first external device 201 and the second external device 202. To this end, the electronic device 200 may control to linearly increase or decrease the volume level of the sound from each of the external devices 201 and 202 by mapping location-related information such as distance information and angle information to volume levels. When a time period set as the sound transition period elapses or the second external device 203 comes closer to the electronic device 200 within a threshold distance, the sound from the second external device 202 according to audio playback may be controlled to be output through the speaker of the electronic device 200 at the original volume level, for example, 100.

In operation 660, the electronic device 200 may identify whether switching from the second external device is confirmed. Referring to FIG. 9, the user may confirm the device switching through a user interaction of nodding the head on the electronic device 200 or a voice command indicating the switching, as indicated by reference numeral 940. Referring to FIG. 11A, after the electronic device 200 moves closer to the second external device 202 than to the first external device 201, the electronic device 200 may control the sound from the second external device 202 according to the audio playback to be output through the speaker of the electronic device 200 at the original volume level, for example, 100, in response to switching to the second external device 202 being determined by a user selection.

In response to the confirmation of switching to the second external device 202, the electronic device 200 may notify each of the first external device 201 and the second external device 202 of the confirmation. Accordingly, the first external device 201 may wait after ending the playback in operation 665, and the second external device 202 may perform playback in operation 670. Referring to FIG. 9, as indicated by reference numeral 950, when the sound connection switching is completed with the electronic device 200, the second external device 202 may display a feedback indicating completion of the sound connection on a screen or provide it by a connection sound.

On the contrary, when the switching to the second external device 202 is not confirmed, for example, when the user cancels the switching to maintain the current sound connection, the electronic device 200 may notify each of the first external device 201 and the second external device 202 of this. Accordingly, the first external device 201 may resume the playback in operation 675, and the second external device 202 may wait after ending the playback in operation 680. In an embodiment, when the switching to the second external device 202 is canceled, the first external device 201 may resume the playback and output sound through the speaker of the electronic device 200. In addition, the second external device 202 may wait for reconnection to the electronic device 200, while maintaining the playback rather than ending the playback. For example, during video playback, the second external device 202 may display only a video in a muted state, while waiting for reconnection to the electronic device 200.

In order to describe changes in the output magnitude of sound, when the electronic device attempts to switch from the first external device to the second external device and then returns again to the first external device according to an embodiment, FIG. 11B may be referred to. FIG. 11B illustrates changes in the volume level of sound, when the electronic device 200 attempts to switch to the second external device 202 and then returns to the first external device 201 without completing the switching. As illustrated in FIG. 11B, even when returning to the first external device 201, which is the previous device, without completing switching, the electronic device 200 may output a sound indicator effect with a fade-out/fade-in effect through the speaker during a sound transition period.

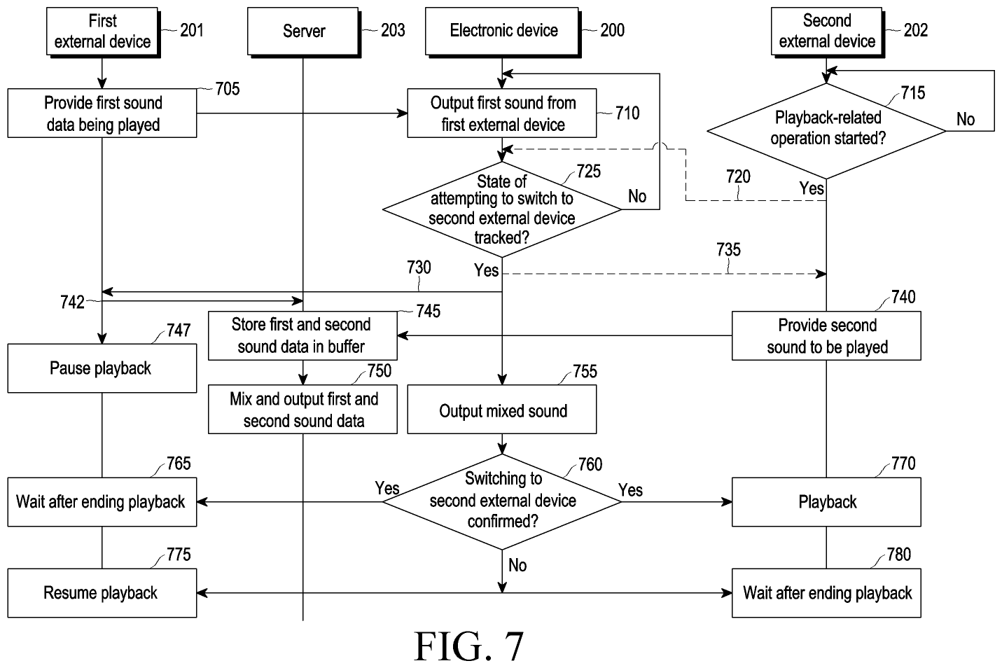

FIG. 7 is a flowchart illustrating signal transmission/reception between components during sound mixing in a server according to an embodiment. Operations 705 to 735 of FIG. 7 are identical to operations 605 to 635 of FIG. 6, and operations 760 to 780 of FIG. 7 are identical to operations 660 to 680 of FIG. 6. Accordingly, their detailed descriptions will be omitted.

In an embodiment, when a condition for switching to the second external device 202 is satisfied, sound data from the first external device 201 and the second external device 202 may be temporarily stored in a server 203, and the server 203 may perform mixing using the stored data.

Referring to FIG. 7, the second external device 202 may provide second sound data to be played to the server 203 in operation 740, and the first external device 201 may provide first sound data to the server 203 in operation 742. For example, the first sound data provided to the server 203 may be at least a portion of first sound data provided to the electronic device 200. For example, on the assumption that the first sound data according to playback is provided from the first external device 201 to the electronic device 200 in units of a specific amount (e.g., 20 seconds), when a switching attempt state is detected, a portion of the first sound data corresponding to a specified amount (e.g., 10 seconds) from a current playback time may be provided to the server 203. In response to the detection of the switching attempt state, a specific amount of second sound data (e.g., 10 seconds) may also be provided from the second external device 202 to the server 203. Accordingly, the server 203 may store the first and second sound data in a buffer in operation 745, and mix the first and second sound data in operation 750. The server 203 may provide the mixed data to the electronic device 200, so that the electronic device 200 may output a mixed sound through the speaker (e.g., the speaker unit 355 of the electronic device 200) in operation 755. For example, when the electronic device 200 is a wearable electronic device such as an earphone, it may be worn on the user's ear, and the mixed sound may be output through a built-in speaker.

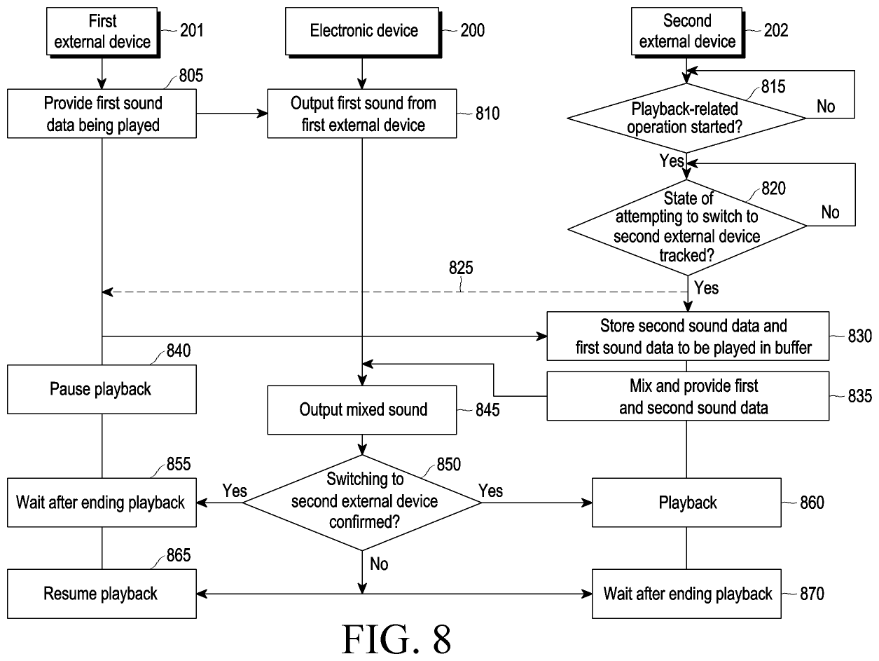

FIG. 8 is a flowchart illustrating signal transmission and reception between components during sound mixing in an external device according to an embodiment. Operations 805 and 810 of FIG. 8 are identical to operations 605 and 610 of FIG. 6, and operations 850 to 870 of FIG. 8 are identical to operations 660 to 680 of FIG. 6. Accordingly, their detailed descriptions will be omitted.

Referring to FIG. 8, the second external device 202 may identify whether a playback-related operation is started in operation 815, and identify whether a state of attempting to switch to the second external device 202 is tracked, based on the identification of the playback-related operation in operation 820. For example, the state of attempting to switch to the second external device 202 may be identified based on whether the electronic device 200 approaches within a threshold distance from the second external device 202 or whether an angle of the electronic device 200 changes to a horizontal angle equal to or greater than a threshold.

Based on the identification of the state of attempting to switch to the second external device 202, the second external device 202 may notify the first external device 201 of this in operation 825. The second external device 202 may receive first sound from the first external device 201, and store second sound data and first sound data to be played in a buffer in operation 830. While the first sound data and the second sound data are temporarily stored, playback in the first external device 201 may be paused in operation 840. The second external device 202 may mix the first sound data and the second sound data in operation 835. The second external device 202 may provide the mixed data to the electronic device 200, so that the electronic device 200 may output mixed sound through the speaker in operation 845.

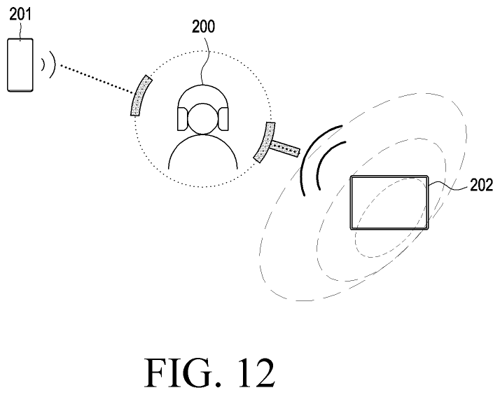

While it has been described with reference to FIGS. 11A and 11B that a sound indicator effect of applying a fade-out/fade-in effect that changes according to a proximity distance is output, by way of example, a sound indicator effect of applying a spatial sound effect may also be output. This will be described in detail with reference to FIGS. 12 to 14B.

FIG. 12 is a diagram illustrating a spatial sound effect according to the direction of each of a first external device and a second external device according to an embodiment.

Referring to FIG. 12, the electronic device 200 may output first sound and second sound with different phases through the speaker in response to the locations of the external devices 201 and 202. For example, in FIG. 12, since the distance to the second external device 202 is smaller than the distance to the first external device 201, each sound data may be processed such that the first sound from the first external device 201 is heard like from a farther distance than the second sound from the second external device 202. To this end, the electronic device 200 may process the volume level of the first sound to be small and the volume level of the second sound to be large. In addition, when the first external device 201 is located on the left side of the electronic device 100 and the second external device 202 is located on the right side of the electronic device 100, the first sound may be output at a small volume level through a left speaker, and the second sound may be output at a large volume level through a right speaker in a pair of electronic devices 200 (e.g., an earphone that may be worn on the right ear and an earphone that may be worn on the left ear), so that the user may hear them directionally.

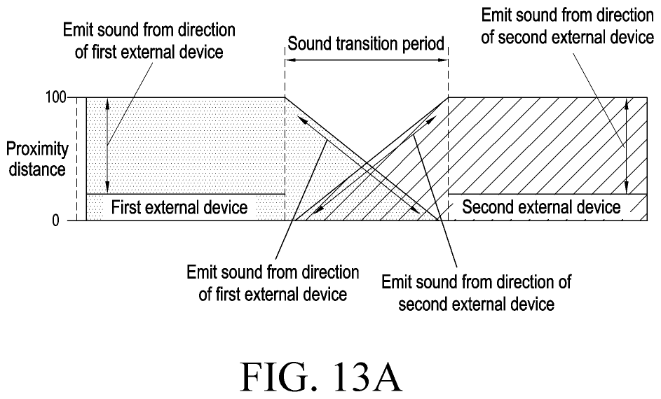

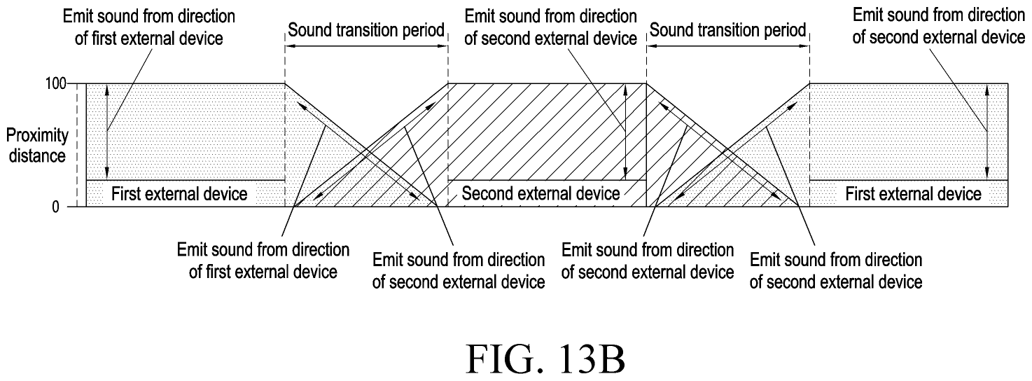

For example, referring to FIG. 13A, when the electronic device 200 is close to the first external device 201, first sound data may be processed so that it sounds as if sound is emitted from the direction of the first external device 201. In a sound transition period, the first sound data and second sound data may be mixed and output so that sound is emitted from the direction of the first external device 201 and sound is emitted from the direction of the second external device 202 at the same time. After the sound transition period, the electronic device 200 may process the second sound data so that sound is emitted from the direction of the second external device 202.

FIG. 13B illustrates changes in the spatial sound effect, when the electronic device 200 attempts to switch to the second external device 202 and then returns to the first external device 201 without completing the switching. Even when returning to the first external device 201 being the previous device without completing the switching as illustrated in FIG. 13B, the electronic device 200 may output a sound indicator effect of applying a spatial sound effect through the speaker during the sound transition period.

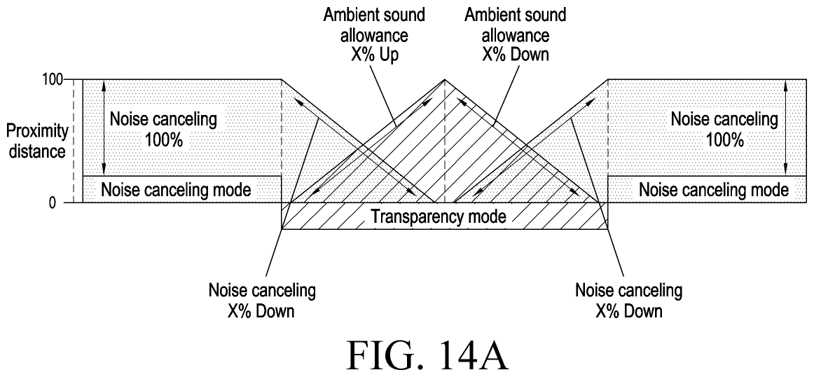

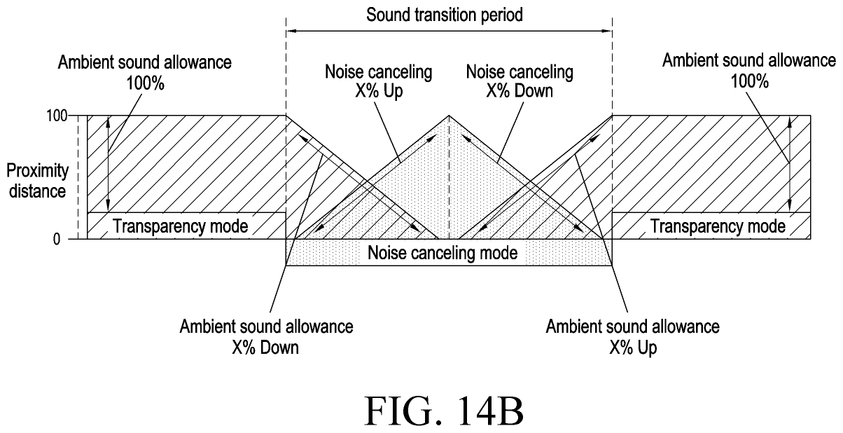

While it has been described above that the sound indicator effect is output according to a proximity distance and a spatial location, by way of example, the method of outputting the sound indicator effect may not be limited thereto, and any method is available as far as it allows the user to recognize through sound that switching to a sound connection target is possible. For example, the sound indicator effect may be output by switching between the noise canceling mode and the transparency mode. This will be described in detail with reference to FIGS. 14A and 14B.

FIG. 14A is a diagram illustrating switching between the noise canceling mode and the transparency mode during switching from a first external device to a second external device according to an embodiment, and FIG. 14B is a diagram illustrating switching between the noise canceling mode and the transparency mode, during switching from a first external device to a second external device and then returning to the first external device according to an embodiment.

The noise canceling mode may refer to a mode in which the electronic device 200 blocks or cancels out ambient noise so that sound may be heard without noise. The transparency mode may refer to a mode in which external sound may be heard. This mode may be referred to as an ambient mode or a transparency mode. For example, in the transparency mode, external sound may be amplified during music listening, so that the user may recognize a surrounding situation while wearing the electronic device 200.

Referring to FIG. 14A, when the electronic device 200 outputs first sound of the first external device 201 in the noise canceling mode within a proximity distance, the degree of noise cancellation may be 100%. For example, the electronic device 200 may output the first sound in which 100% of ambient noise is blocked. In a sound transition period, the electronic device 200 may output the first sound by gradually reducing ambient noise blocking of 100% by, for example, X % in a stepwise manner and then output the first sound by gradually increasing it by X % in a stepwise manner, depending on the distance to the first external device 201. At this time, the electronic device 200 may output second sound by gradually increasing ambient noise allowance by X % in a stepwise manner and then output the second sound by gradually reducing ambient noise allowance by X % in a stepwise manner, depending on the distance to the second external device 202. After the sound transition period, the electronic device 200 may output the second sound by blocking 100% of the ambient noise.

FIG. 14B illustrates an example in which an electronic device operates in the transparency mode, temporarily switches from the transparency mode to the noise canceling mode during a sound transition period, and then operates in the transparency mode again after the sound transition period.

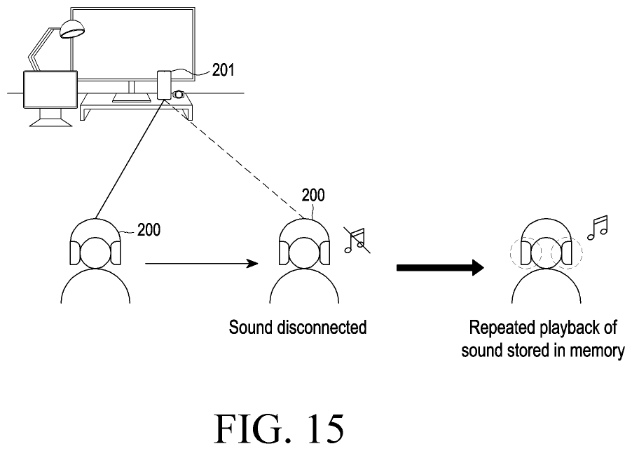

FIG. 15 is a diagram a sound output method in a repeated playback manner, when a first external device is disconnected during output of first sound of the first external device according to an embodiment of the disclosure.

Referring to FIG. 15, while the user wearing the electronic device 200 is connected to the first external device 201 and first sound of the first external device 201 is output, the distance to the first external device 201 may increase due to movement (e.g., spatial movement) of the user, and the sound connection to the first external device 201 may be disconnected. In an embodiment, the electronic device 200 may output the first sound of the first external device 201, while storing a specific amount of first sound data that may be played back during a specific time period. Accordingly, when the distance to the first external device 201 is equal to or greater than a threshold distance, and thus the sound connection to the first external device 201 is disconnected, the electronic device 200 may repeatedly play back the stored sound data. When the first external device 201 is detected within the threshold distance during the repeated playback of the stored sound data, the electronic device 200 may output the first sound from the first external device 201 through the speaker unit (e.g., the speaker unit 355 of FIG. 3) of the electronic device 200 after reconnecting to the first external device 201.

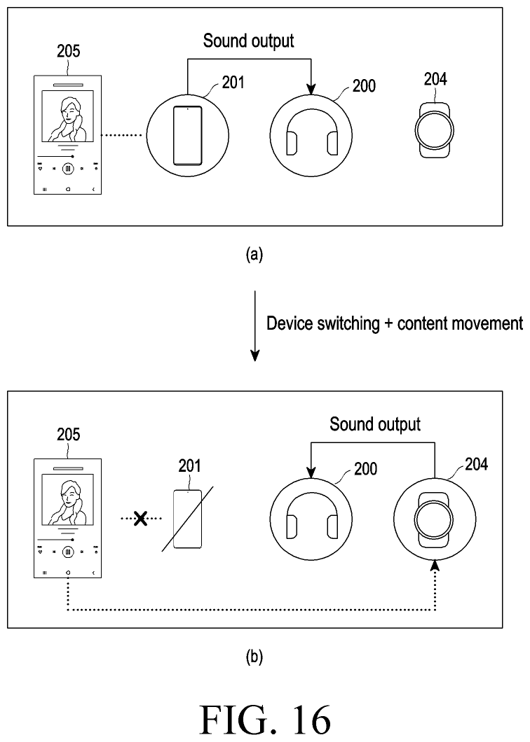

FIG. 16 is a diagram illustrating a method of outputting sound from a different third external device, when a first external device is disconnected during output of first sound of the first external device according to an embodiment.

Referring to FIG. 16(a), the first external device 201 may be playing audio through a content provider 205, and the user wearing the electronic device 200 may be connected to the first external device 201 and thus the electronic device 200 may be outputting first sound of the first external device 201. Referring to FIG. 16(b), when the first external device 201 is disconnected, the electronic device 200 may be automatically connected to another external device 204 (e.g., a smart watch) connected to the first external device 201. The other external device 204 may have the same user account and the same installed application as the first external device 201, so that it may receive content (e.g., audio data) and related information (e.g., a playback time point, a song, and a volume level) through the content provider 205, thereby enabling continuous sound playback. In this way, when there is an alternative device capable of linking media content, continuous sound output may be enabled through the speaker of the electronic device 200.

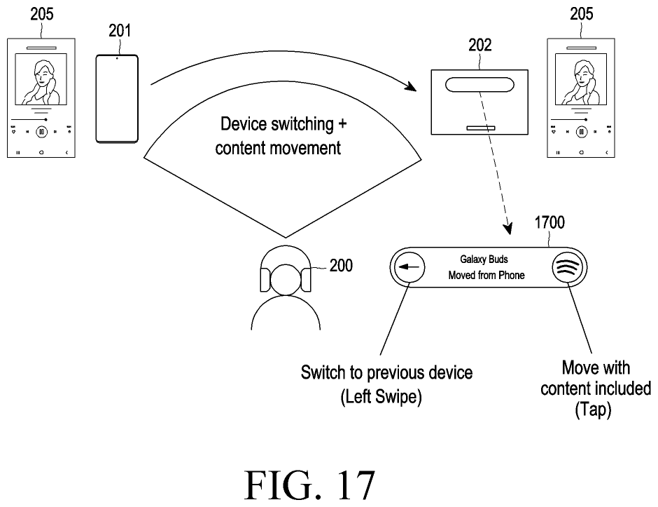

FIG. 17 is an exemplary diagram illustrating a method of outputting first sound for first content from a second external device instead of a first external device, during output of the first sound for the first content from the first external device in an electronic device according to an embodiment.

Referring to FIG. 17, the first external device 201 may be playing audio through the content provider 205, and the user wearing the electronic device 200 may be connected to the first external device 201 and thus the electronic device 200 may be outputting first sound of the first external device 201. When the second external device 202 is identified as a sound connection target, the electronic device 200 may be connected to the second external device 202.

The second external device 202 may have the same user account and the same installed application as the first external device 201, so that it may receive content (e.g., audio data) and related information (e.g., a playback time point, a song, and a volume level) through the content provider 205 and play sound.

The user may select whether to switch by selecting an object on a user interface 1700 for device switching displayed on a screen of the second external device 202. In this case, even if the service connection target changes, continuous sound output may be enabled through the speaker of the electronic device 200.

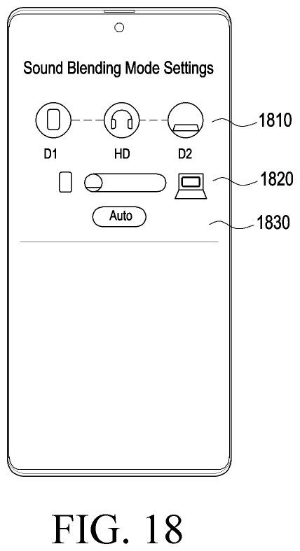

When audio data being played on the first external device 201 and audio data being played on the second external device 202 are different, different sounds may be output simultaneously through the speaker of the electronic device 200. FIG. 18 illustrates a screen for sound mixing-related settings according to an embodiment.

Referring to FIG. 18, on a settings screen, a first component 1810 may indicate a connection state between devices, a second component 1820 may indicate a device having a volume to which priority will be given out of the first external device 201 and the second external device 202, and a third component 1830 may indicate a function of automatically balancing sound between the first external device 201 and the second external device 202. For example, when a music app is running on the first external device 201 and a video is being watched on the second external device 202, each of the external devices 201 and 202 may transmit sound data to the electronic device 200 in real time. Further, each of the external devices 201 and 202 may transmit information set through the settings screen of FIG. 18 to the electronic device 200.

The electronic device 200 may output mixed data based on the set information through the speaker during a specific time period according to the priority. Accordingly, the user of the electronic device 200 may listen to different sounds at the same time. “Based on” as used herein covers based at least on.

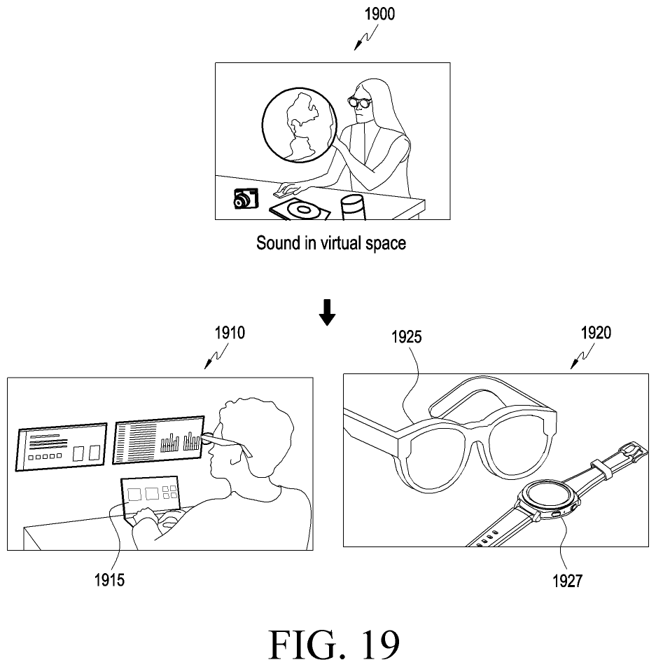

FIG. 19 is an exemplary diagram illustrating a method of outputting sound in a virtual space according to an embodiment. Referring to FIG. 19, in the case where sound is output 1900 in a virtual space, when a switching intention is sensed, data including sound playback information and content information may be mixed, and then the mixed data may be provided to a desired device or a server. For example, the user may select an external device 1915 in the virtual space or a desired type of device 1925 or 1927 to share sound.

In an embodiment, as a sound indicator effect is output through the speaker to indicate that a sound connection target may be switched, as when the user holding the electronic device moves away from the first external device to be closer to the second external device, the user may intuitively know that the switching is possible. Further, the user may be guided to select a sound switching target by notifying the user that the switching is possible using the sound indicator effect. Accordingly, the electronic device may clearly identify the user's intention as to whether the user wants to switch sound to another external device.

The electronic device according to an embodiment of the disclosure may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B”, “at least one of A and B”, “at least one of A or B”, “A, B, or C”, “at least one of A, B, and C”, and “at least one of A, B, or C”, may include any one of, or all possible combinations of the items enumerated together in a corresponding one of the phrases. As used herein, such terms as “1^{st}” and “2^{nd}”, or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with”, “coupled to”, “connected with”, or “connected to” another element (e.g., a second element), it means that the element may be coupled with the other element directly (e.g., wiredly), wirelessly, or via a third element.

As used in connection with an embodiment of the disclosure, the term “module” may include a unit implemented in hardware, software, or firmware, and may interchangeably be used with other terms, for example, logic, logic block, part, or circuitry. A module may be a single integral component, or a minimum unit or part thereof, adapted to perform one or more functions. For example, according to an embodiment, the module may be implemented in a form of an application-specific integrated circuit (ASIC). Thus, each “module” herein may comprise circuitry.

An embodiment as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to an embodiment of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to an embodiment, each component (e.g., a module or a program) of the above-described components may include a single entity or multiple entities, and some of the multiple entities may be separately disposed in different components. According to an embodiment, one or more of the above-described components may be omitted, or one or more other components may be added. Alternatively or additionally, a plurality of components (e.g., modules or programs) may be integrated into a single component. In such a case, according to an embodiment, the integrated component may still perform one or more functions of each of the plurality of components in the same or similar manner as they are performed by a corresponding one of the plurality of components before the integration. According to an embodiment, operations performed by the module, the program, or another component may be carried out sequentially, in parallel, repeatedly, or heuristically, or one or more of the operations may be executed in a different order or omitted, or one or more other operations may be added.

According to an embodiment, in a storage medium storing instructions configured to, when executed by at least one processor 320 of the electronic device 200, cause the electronic device to perform at least one operation, the at least one operation may include outputting first sound from a first external device through a speaker unit of the electronic device, identifying that a condition for switching to a second external device is satisfied, while outputting the first sound, based on the condition for switching to the second external device being satisfied, storing the first sound from the first external device and second sound from the second external device, mixing the first sound and the second sound, identifying an input for selecting switching to the second external device, while outputting the mixed sound, and stopping outputting the first sound and outputting the second sound through the speaker unit, in response to the input for selecting switching to the second external device.

1. An electronic device comprising:
a communication module comprising communication circuitry;
a speaker unit comprising a speaker;
at least one processor comprising processing circuitry; and
memory storing instructions that, when executed by the at least one processor individually and/or collectively, cause the electronic device to:
output first sound from a first external device through the speaker unit,
identify that a condition for switching to a second external device is satisfied, while outputting the first sound,
based on the condition for switching to the second external device being satisfied, store the first sound from the first external device and second sound from the second external device,
mix the first sound and the second sound,
identify an input for selecting switching to the second external device, while outputting the mixed sound, and
stop outputting the first sound and output the second sound through the speaker unit, in response to the input for selecting switching to the second external device.

2. The electronic device of claim 1, wherein the instructions, when executed by the at least one processor individually and/or collectively, are configured to cause the electronic device to:
identify at least one of a direction in which the electronic device is directed or a distance to the second external device, and
identify that the condition for switching to the second external device is satisfied at least by identifying the at least one of the direction in which the electronic device is directed or the distance to the second external device.

3. The electronic device of claim 2, wherein the instructions, when executed by the at least one processor individually and/or collectively, are configured to cause the electronic device to, in case that the distance from the electronic device to the second external device is within a threshold distance with respect to the electronic device, identify that the condition for switching to the second external device is satisfied.

4. The electronic device of claim 1, wherein the instructions, when executed by the at least one processor individually and/or collectively, are configured to cause the electronic device to:
detect an event associated with the output of the second sound from the second external device, and
identify that the condition for switching to the second external device is satisfied, in response to the detection of the event.

5. The electronic device of claim 1, wherein the instructions, when executed by the at least one processor individually and/or collectively, are configured to cause the electronic device to identify the input for selecting switching to the second external device at least by identifying at least one of a touch input of a specified type, an interaction input of a specified type, or a voice input through a microphone of the electronic device.

6. The electronic device of claim 1, wherein the instructions, when executed by the at least one processor individually and/or collectively, are configured to cause the electronic device to:
identify at least one of a position, direction, or distance of each of the first external device and the second external device with respect to the electronic device, based on at least one of a ultra wide band (UWB) communication scheme or Bluetooth low energy (BLE) communication scheme of the communication module, and
mix the first sound and the second sound at least by adjusting output magnitudes of the first sound and the second sound based on the identified at least one of the position, direction, or distance of each of the first external device and the second external device.

7. The electronic device of claim 1, wherein the instructions, when executed by the at least one processor individually and/or collectively, are configured to cause the electronic device to mix the first sound having an output magnitude gradually decreasing as the distance to the first external device increases, and the second sound having an output magnitude gradually increasing as the distance to the second external device decreases.

8. The electronic device of claim 1, wherein the instructions, when executed by the at least one processor individually and/or collectively, are configured to cause the electronic device to:
in case that the electronic device is in a noise canceling mode, switch from the noise canceling mode to a transparency mode when outputting the mixed sound, and
return from the transparency mode to the noise canceling mode, in response to the input for selecting switching to the second external device.

9. The electronic device of claim 1, wherein the instructions, when executed by the at least one processor individually and/or collectively, are configured to cause the electronic device to limit the output of the second sound through a speaker of the second external device, in response to the input for selecting switching to the second external device.

10. The electronic device of claim 1, wherein the instructions, when executed by the at least one processor individually and/or collectively, are configured to cause the electronic device to, in case that the input for selecting switching to the second external device is not identified, stop outputting the second sound and output the first sound through the speaker unit.

11. An operation method for providing sound in an electronic device, the method comprising:
outputting first sound from a first external device through a speaker unit of the electronic device;
identifying that a condition for switching to a second external device is satisfied, while outputting the first sound;
based on the condition for switching to the second external device being satisfied, storing the first sound from the first external device and second sound from the second external device;
mixing the first sound and the second sound;
identifying an input for selecting switching to the second external device, while outputting the mixed sound; and
stopping outputting the first sound and outputting the second sound through the speaker unit, in response to the input for selecting switching to the second external device.

12. The operation method of claim 11, wherein identifying that the condition for switching to the second external device is satisfied includes:
identifying at least one of a direction in which the electronic device is directed or a distance to the second external device; and
identifying that the condition for switching to the second external device is satisfied by identifying the at least one of the direction in which the electronic device is directed or the distance to the second external device.

13. The operation method of claim 12, wherein identifying that the condition for switching to the second external device is satisfied includes, in case that the distance from the electronic device to the second external device is within a threshold distance with respect to the electronic device, identifying that the condition for switching to the second external device is satisfied.

14. The operation method of claim 11, wherein identifying that the condition for switching to the second external device is satisfied includes:
detecting an event associated with the output of the second sound from the second external device; and
identifying that the condition for switching to the second external device is satisfied, in response to the detection of the event.

15. A storage medium storing instructions configured to, when executed by a processor of an electronic device, cause the electronic device to perform at least one operation, wherein the at least one operation includes:
outputting first sound from a first external device through a speaker unit of the electronic device;
identifying that a condition for switching to a second external device is satisfied, while outputting the first sound;
based on the condition for switching to the second external device being satisfied, storing the first sound from the first external device and second sound from the second external device;
mixing the first sound and the second sound;
identifying an input for selecting switching to the second external device, while outputting the mixed sound; and
stopping outputting the first sound and outputting the second sound through the speaker unit, in response to the input for selecting switching to the second external device.
